(19) United States
(12) Patent Application Publication
(10) Pub. No.: US 2018/0099904 A1
(43) Pub. Date: Apr. 12, 2018

(54) METHOD OF MANUFACTURING STRENGTHENED GLASS, STRENGTHENED GLASS OBTAINED BY THE METHOD, AND ELECTRONIC DEVICE INCLUDING THE STRENGTHENED GLASS

(71) Applicant: Samsung Display Co. Ltd., Yongin-si (KR)

(72) Inventors: Jeong Woo PARK, Yongin-si (KR); Hyun Joon OH, Seongnam-si (KR); Woo Jin CHO, Yongin-si (KR); Seung Ho KIM, Asan-si (KR); Hee Kyun SHIN, Incheon (KR); Jong Hoon YEUM, Seoul (KR); Hoi Kwan LEE, Suwon-si (KR)

(21) Appl. No.: 15/592,259

(22) Filed: May 11, 2017

(30) Foreign Application Priority Data
Oct. 6, 2016 (KR) 10-2016-0129142

(51) Int. Cl. C03C 21/00; C03C 15/00

(52) U.S. Cl. CPC C03C 21/002; C03C 15/00

(57) ABSTRACT

A method of manufacturing strengthened glass includes: preparing glass including blocking patterns on a surface thereof, portions of the surface exposed between the blocking patterns; forming a metal particle layer on the portions of the surface of the glass exposed between the blocking patterns; removing the blocking patterns from the surface of the glass, to maintain the metal particle layer on the surface of the glass; with the metal particle layer maintained on the surface of the glass, etching the surface of the glass using the metal particle layer as an etching mask to form an etched surface of the glass, such etched surface including protruding patterns spaced apart from each other by portions of a common reference surface; and chemically strengthening the etched surface of the glass at the protruding patterns and at the reference surface.

This application claims priority to Korean Patent Application No. 10-2016-0129142, filed on Oct. 6, 2016, and all the benefits accruing therefrom under 35 U.S.C. § 119, the contents of which in their entirety are herein incorporated by reference.

### BACKGROUND

### 1. Field

The present disclosure relates to a method of manufacturing strengthened glass, strengthened glass obtained by the method, and an electronic device including the strengthened glass.

### 2. Description of the Related Art

In accordance with developments in multimedia technology, electronic devices such as display devices have increasingly become important. The surface of a display portion of a display device may be formed of a material having relatively high light transmittance such as, for example, glass. An example of the glass is soda lime glass. Soda lime glass contains a relatively large amount of alkali ions, so there is a problem that the alkali ions can easily elute. In addition, soda lime glass has a disadvantage that the strength thereof is relatively weak compared to other glass materials.

### SUMMARY

Exemplary embodiments of the present disclosure provide a method of manufacturing strengthened glass with an improved reinforcement efficiency, and strengthened glass obtained by the method and having an antireflection effect or an aesthetic effect.

Exemplary embodiments of the present disclosure also provide an electronic device including strengthened glass, such electronic device capable of improving the quality of an image displayed in a display portion thereof and at the same time, providing an aesthetic effect to a non-display portion thereof.

However, exemplary embodiments of the present disclosure are not restricted to those set forth herein. The above and other exemplary embodiments of the present disclosure will become more apparent to one of ordinary skill in the art to which the present disclosure pertains by referencing the detailed description of the present disclosure given below.

According to an exemplary embodiment of the invention, there is provided a method of manufacturing strengthened glass. The method including: preparing glass including blocking patterns on a surface thereof, portions of the surface exposed between the blocking patterns; forming a metal particle layer on the portions of the surface of the glass exposed between the blocking patterns; removing the blocking patterns from the surface of the glass, to maintain the metal particle layer on the surface of the glass; with the metal particle layer maintained on the surface of the glass, etching the surface of the glass using the metal particle layer as an etching mask to form an etched surface of the glass, such etched surface including protruding patterns spaced apart from each other by portions of a common reference surface; and chemically strengthening the etched surface of the glass at the protruding patterns and at the reference surface.

In an exemplary embodiment, the preparing the glass having the blocking patterns on the surface thereof, may include preparing a stamp which has a patterned surface including concave portions and convex portions, providing a blocking pattern forming material on the convex portions of the stamp, and forming the blocking patterns by transferring the blocking pattern forming material from the stamp onto the surface of the glass by using the stamp.

In an exemplary embodiment, the convex portions of the stamp may include first convex portions which lengthwise extend in a first direction, and second convex portions which lengthwise extend in a second direction which intersects the first direction, the first and second convex portions forming a lattice-shape in a plan view.

In an exemplary embodiment, the blocking patterns may include a material including trichlorosilane, trimethoxysilane, or dimethyldichlorosilane.

In an exemplary embodiment, the blocking patterns may be hydrophobic relative to the surface of the glass.

In an exemplary embodiment, the method may further include between the preparing the glass including the blocking patterns on the surface thereof and the forming the metal particle layer: treating the portions of the surface of the glass exposed by the blocking patterns with tin ions or fluorine ions.

In an exemplary embodiment, metal particles in the metal particle layers may be silver (Ag) particles, and the forming the metal particle layers may include precipitating Ag on the parts of the surface of the glass treated with the tin ions or the fluorine ions.

In an exemplary embodiment, the method may further include, after the etching the surface of the glass: immersing the glass having the etched surface in a nitric add solution.

In an exemplary embodiment, the removing the blocking patterns to maintain the metal particle layer on the surface of the glass may include thermally treating the glass having the blocking patterns and the metal particle layer thereon at a temperature of 350° C. to about 450° C.

In an exemplary embodiment, the chemically strengthening the etched surface of the glass, may include substituting first alkali metal ions in the protruding patterns and at the reference surface of the glass with second alkali metal ions having a larger ionic radius than the first alkali metal ions.

In an exemplary embodiment of the invention, there is provided a strengthened glass. The strengthened glass includes a chemically strengthened patterned surface, such patterned surface defined by a plurality of chemically strengthened protruding patterns protruding from a common reference surface. The chemically strengthened protruding patterns are regularly arranged to be spaced apart from one another by portions of the common reference surface, in a first direction and a second direction which intersects the first direction.

In an exemplary embodiment, the glass may further include: a glass body which defines the common reference surface from which the chemically strengthened protruding patterns are protruded, such glass body commonly connecting the chemically strengthened protruding patterns to one another in the first and second directions.

In an exemplary embodiment, sidewalls of the chemically strengthened protruding patterns may be inclined with respect to the common reference surface.

In an exemplary embodiment, the chemically strengthened protruding patterns may be circular in the plan view.

In an exemplary embodiment, the patterned surface may have a compressive stress of about 600 megapascals (MPa) to about 2000 MPa.

In an exemplary embodiment of the invention, there is provided an electronic device. The electronic device includes a display portion at which an image is displayed; a non-display portion at which the image is not displayed; and an outer glass disposed in the display portion and in the non-display portion. An outer glass surface of the display portion of the electronic device is defined by first protruding patterns which protrude from a first reference surface, an outer glass surface of the non-display portion of the electronic device is defined by second protruding patterns which protrude from a second reference surface, and a maximum height of the second protruding patterns from the first reference surface is greater than a maximum height of the first protruding patterns from the second reference surface.

In an exemplary embodiment, the first protruding patterns and the second protruding patterns may be spaced apart from each other, and a minimum distance between the second protruding patterns may be greater than a minimum distance between the first protruding patterns.

In an exemplary embodiment, the first protruding patterns spaced apart from each other may be regularly arranged in a first direction and a second direction which intersects the first direction, the second protruding patterns spaced apart from each other may be regularly arranged in the first and second directions, and tops of the first protruding patterns and tops of the second protruding patterns may be located at the same level from a common reference within the outer glass.

In an exemplary embodiment, the maximum height of the first protruding patterns may be about 100 nanometers (nm) to about 150 nm, and the maximum height of the second protruding patterns may be about 1 micrometer (μm) to about 10 (μm).

In an exemplary embodiment, the outer glass surface of the display portion may include chemically strengthened first protruding patterns which protrude from the first reference surface, and the outer glass surface of the non-display portion may include chemically strengthened second protruding patterns which protrude from the second reference surface.

According to the aforementioned and other exemplary embodiments of the present disclosure, strengthened glass having a patterned surface can be applied to define an outer surface of a display portion of an electronic device so as to provide an antireflection effect. Also, the strengthened glass can be applied to define an outer surface of a non-display portion of the electronic device so as to reflect different colors of light depending on the angle from which it is viewed.

In addition, the reinforcement efficiency and the durability of glass can be improved by forming fine patterns on a surface of the glass to increase a total surface area of the surface of the glass, and then chemically strengthening the surface of the glass.

Other features and exemplary embodiments may be apparent from the following detailed description, the drawings, and the claims.

### BRIEF DESCRIPTION OF THE DRAWINGS

The above and other exemplary embodiments and features of the present disclosure will become more apparent by describing in detail exemplary embodiments thereof with reference to the attached drawings, in which:

FIG. 1 is a perspective view of an exemplary embodiment of strengthened glass according to the invention;

FIG. 2 is a cross-sectional view taken along line II-II′ of FIG. 1;

FIG. 3 is a perspective view of an exemplary embodiment of an electronic device including strengthened glass according to the invention;

FIG. 4 is a cross-sectional view taken along lines IVa-IVa′ and IVb-IVb′ of FIG. 3;

FIG. 5 is a flowchart illustrating an exemplary embodiment of a method of manufacturing strengthened glass according to the invention;

FIGS. 6 through 17 are various schematic and cross-sectional views illustrating the method of FIG. 5; and

FIGS. 18A through 18D are photographs of strengthened glass fabricated according to a preparation example of the present disclosure.

### DETAILED DESCRIPTION

Features of the invention and methods of accomplishing the same may be understood more readily by reference to the following detailed description of exemplary embodiments and the accompanying drawings. The invention may, however, be embodied in many different forms and should not be construed as being limited to the embodiments set forth herein. Rather, these embodiments are provided so that this disclosure will be thorough and complete and will fully convey the invention to those skilled in the art, and the invention will only be defined by the appended claims.

It will be understood that when an element or layer is referred to as being related to another element or layer such as being “on,” “connected to” or “coupled to” another element or layer, the element or layer can be directly on, connected or coupled to another element or layer or intervening elements or layers. In contrast, when an s element is referred to as being related to another element or layer such as being “directly on,” “directly connected to” or “directly coupled to” another element or layer, there are no intervening elements or layers present. As used herein, connected may refer to elements being physically, electrically and/or fluidly connected to each other.

Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “below,” “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms “a,” “an” and “the” are intended to include the plural forms as well, including “at least one,” unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof. “At least one” is not to be construed as limiting “a” or “an.” “Or” means “and/or.” As used herein, the term “and/or” includes any and all combinations of one or more of the associated listed items.

In the description that follows, the term “first direction” refers to an arbitrary direction on a particular plane, the term “second direction” refers to a direction intersecting the first direction on the particular plane, and the term “third direction” refers to a direction perpendicular to the particular plane.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Exemplary embodiments of the present disclosure will hereinafter be described with reference to the accompanying drawings.

Electronic devices such as display devices have become relatively smaller and thinner, making such devices more portable. As the portability of electronic devices increases, there is an increasing demand for strengthened glass for increasing the durability of such electronic devices. The strengthened glass may be used to define an outer surface of an electronic device.

First, one or more exemplary embodiment of strengthened glass according to the invention will hereinafter be described.

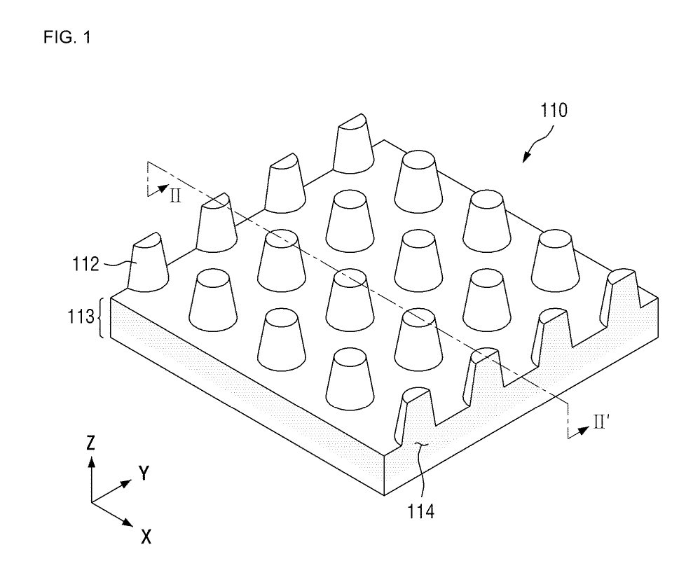

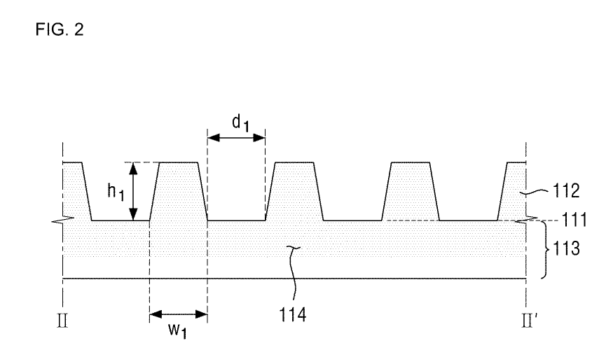

FIG. 1 is a perspective view of an exemplary embodiment of strengthened glass according to the invention. FIG. 2 is a cross-sectional view taken along line II-II′ of FIG. 1.

Referring to FIGS. 1 and 2, strengthened glass 110 includes a protruding pattern 112 provided in plurality, which protrude from an imaginary reference surface 111, and a glass body 113, which is disposed below the protruding patterns 112 and commonly connects the protruding patterns 112 to one another. The glass body 113 and the protruding patterns 112 may form one integral body without physical boundaries therebetween. The glass body 113 may define the reference surface 111.

The strengthened glass 110 may include or be formed of a relatively highly transparent material. In an exemplary embodiment, for example, the strengthened glass 110 may include SiO₂, Al₂O₃, LiO₂ and/or Na₂O, but the present disclosure is not limited thereto. In another example, the strengthened glass 110 may be soda lime glass.

A first surface (in the exemplary embodiment of FIG. 1, the top surface) of the strengthened glass 110 includes a patterned surface. The patterned surface includes the surfaces of the protruding patterns 112 and the surface of the glass body 113. The surface of the glass body 113 may be exposed between protruding patterns 112 adjacent to each other, and may be defined by portions of the reference surface 111.

The protruding patterns 112 may protrude from the reference surface 111 and may be disposed on the glass body 113. The reference surface 111 may be a surface where valleys of the patterned surface of the strengthened glass 110 are located. That is, the reference surface 111 may refer to a first surface (in the exemplary embodiment of FIG. 1, the top surface) of the glass body 113.

The strengthened glass 110 is disposed in a plane defined by first and second directions X and Y. The protruding patterns 112 may be regularly arranged, and spaced apart from one another, in the first and second directions X and Y. The protruding patterns 112 will hereinafter be described in detail.

The sidewalls of the protruding patterns 112 may each be inclined. The inclination angle of the sidewalls of the protruding patterns 112 relative to the reference surface 111 may be about 40 degrees (°) to 85 degrees (°). Each protruding pattern 112 may define a planar area at a base thereof and a planar area at a distal (top) end thereof. These respective planar areas may be different from each other, such as the base planar area being larger than the distal planar area. The base and distal planar areas may be disposed in a plane parallel to that of the strengthened glass 110 and/or the reference surface 111. In an exemplary embodiment, for example, a total the planar area of contact or interface between a bottom surface or base of the protruding patterns 112 and the glass body 113 may be larger than the combined planar area of the top surfaces of the protruding patterns 112,

FIG. 1 illustrates an example in which the top surfaces of the protruding patterns 112 have a predetermined planar area, but in another example, the tops of the protruding patterns 112 may have a pointed tip, e.g., a minimal planar area. Since the sidewalls of the protruding patterns 112 are inclined, the strengthened glass 110 can provide an anti-reflection effect or a “rainbow reflection” effect in which the color of the strengthened glass 110 varies depending on the angle from which the strengthened glass 110 is viewed. The protruding patterns 112 may be substantially circular in a plan view. The term “plan view,” as used herein, means a view of an object from the top of the object (e.g., from a third direction Z).

Referring to FIGS. 1 and 2, for example, a maximum height h₁ of the protruding patterns 112 may be about 100 nanometers (nm) to about 150 nm. The maximum height h₁ refers to the distance from the reference surface 111 to a distal end (top) of the protruding patterns 112 in the third direction Z. A maximum width w₁ of the protruding patterns 112 taken in the plane defined by the first and second X and Y directions may be about 100 nm to about 150 nm. The maximum width w₁ refers to the width of parts of the protruding patterns 112 that are placed in contact or interfaced with the glass body 113.

While FIG. 2 illustrates a view along the first direction X, the structures of FIG. 2 may be applied along the second direction Y. A minimum distance d₁ between adjacent protruding patterns 112 in the first direction X and the minimum distance d₁ between adjacent protruding patterns 112 in the second direction Y may be about 100 nm to about 150 nm. The minimum distance d₁ between the adjacent protruding patterns 112 in the first direction X may be substantially the same as the minimum distance between the adjacent protruding patterns 112 in the second direction Y. In a case in which the maximum height h₁, the maximum width w₁ and the minimum distance d₁ are all within the range of about 100 nm to about 150 nm, the patterned surface of the strengthened glass 110 may have a nano-sized ultrafine structure and may have an antireflection effect for light incident on the strengthened glass 110.

In another example, the maximum height h₁, the maximum width w₁ and the minimum distance d₁ may all be within the range of about 1 micrometer (μm) to about 10 μm. In this example, the patterned surface of the strengthened glass 110 may have a micron-sized ultrafine structure and may provide an aesthetic effect by changing the color of light reflected from the strengthened glass 110 according to the angle from which the strengthened glass 110 is viewed.

An upper portion of the strengthened glass 110 may include a chemically strengthened layer 114, as indicated by the shading in FIGS. 1 and 2. That is, the strengthened glass 110, which includes the protruding patterns 112 connected to one another by the glass body 113, may be chemically strengthened. Specifically, at least a portion of the glass body 113 and each the protruding patterns 112 may be chemically strengthened and may collectively define the chemically strengthened layer 114 of the strengthened glass 110. In an exemplary embodiment, a portion of a thickness of the glass body 113 and an entirety of a height (thickness) of the protruding patterns 112 is may be chemically strengthened to collectively define the chemically strengthened layer 114 of the strengthened glass 110.

In an exemplary embodiment of manufacturing the strengthened glass 110, the chemically strengthened layer 114 may be a layer obtained by replacing sodium ions in a material for forming the strengthened glass 110, with potassium ions. In an exemplary embodiment, for example, the patterned surface (in the exemplary embodiment of FIG. 1, the collective top surface) of the strengthened glass 110 may have a relatively higher concentration of potassium ions than an opposing surface (in the exemplary embodiment of FIG. 1, the bottom surface) of the strengthened glass 110. Also, the patterned surface of the strengthened glass 110 may have a relatively lower concentration of sodium ions than the opposing surface of the strengthened glass 110.

In an exemplary embodiment, for example, the compressive stress of the chemically strengthened layer 114 of the strengthened glass 110 may be about 600 megapascals (MPa) to about 2000 MPa. Also, the thickness of the chemically strengthened layer 114 may be about 30 μm to about 80 μm. The thickness of the chemically strengthened layer 114 may be a maximum cross-sectional thickness (e.g., third direction Z) thereof.

One or more exemplary embodiment of an electronic device according to the invention will hereinafter be described.

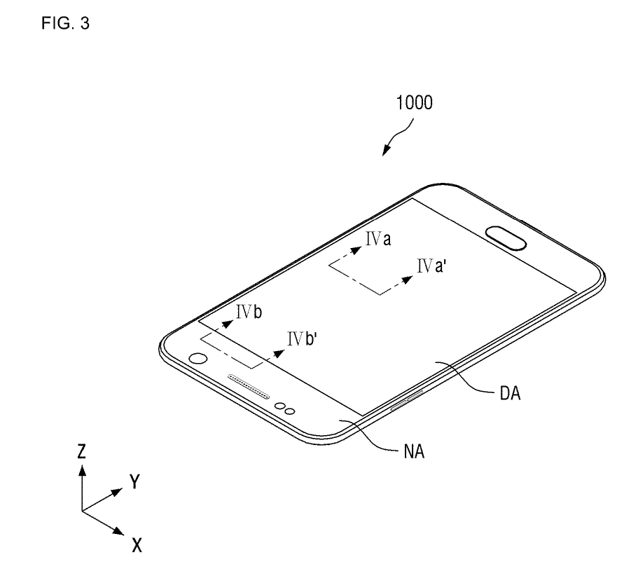

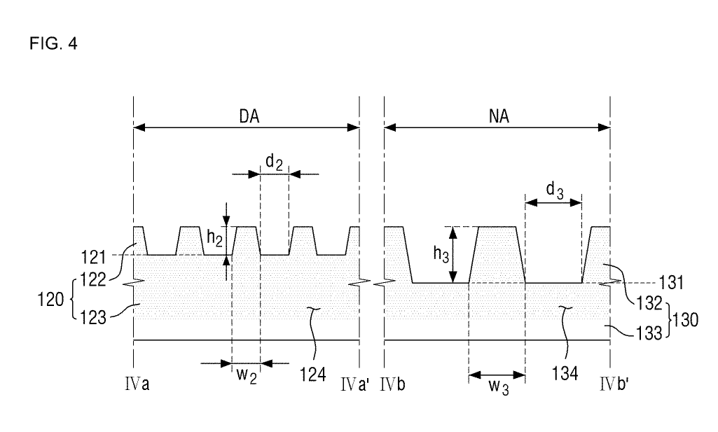

FIG. 3 is a perspective view of an exemplary embodiment of an electronic device including strengthened glass according to the invention. FIG. 4 is a cross-sectional view taken along lines IVa-IVa′ and IVb-IVb′ of FIG. 3.

Referring to FIGS. 3 and 4, an electronic device 1000 includes a display portion DA and a non-display portion NA. The display portion DA may refer to a portion of the electronic device 1000 where an image is realized, and the non-display portion NA may refer to a remainder of the entire electronic device 1000 except for the display portion DA, such as a body, bezel and rear portions of the electronic device 1000. The electronic device 1000 may be disposed in a plane defined by the first and second directions X and Y. The display portion DA and the non-display portion NA of the electronic device 1000 may define an entire planar area thereof in the plane defined by the first and second directions X and Y.

The outermost surface of the display portion DA of the electronic device 1000 may be made of strengthened glass 120, and the outermost surface of the non-display portion NA of the electronic device 1000 may be made of strengthened glass 130. The strengthened glass 120 of the display portion DA and the strengthened glass 130 of he non-display portion NA may both have a patterned surface.

The patterned surface of the strengthened glass 120 of the display portion DA includes a first protruding pattern 122 provided in plurality, which protrude from an imaginary first reference surface 121, and a first glass body 123, which is disposed below the first protruding patterns 122 and commonly connects the first protruding patterns 122 to one another. The patterned surface of the strengthened glass 130 of the non-display portion NA includes a second protruding pattern 132 provided in plurality, which protrude from an imaginary second reference surface 131, and a second glass body 133 which is disposed below the second protruding patterns 132 and commonly connects the second protruding patterns 132 to one another. The first glass body 123 and the first protruding patterns 122 may be formed in one integral body, and the second glass body 133 and the second protruding patterns 132 may be formed in one integral body. The first glass body 123, which is disposed in the display portion DA, and the second glass body 133, which is disposed in the non-display portion NA, may form one integral body without a physical boundary therebetween. The glass body 123 and 133 may define the reference surfaces 121 and 131.

While FIG. 4 illustrates a view along the first direction X, the structures of FIG. 4 may be applied along the second direction Y. The first protruding patterns 122 may protrude from the first reference surface 121 and may be disposed on the first glass body 123. The first protruding patterns 122 may be regularly arranged, and spaced apart from one another, in the first and second directions X and Y. The sidewalls of the first protruding patterns 122 may be inclined with respect to the first reference surface 121. The first protruding patterns 122 may be substantially circular in a plan view. The second protruding patterns 132 may protrude from the second reference surface 131 and may be disposed on the second glass body 133. The second protruding patterns 132 may be regularly arranged, and spaced apart from one another, in the first and second directions X and Y. The sidewalls of the second protruding patterns 132 may be inclined with respect to the second reference surface 131. The second protruding patterns 132 may be substantially circular in a plan view. The distal ends or tops of the first protruding patterns 122 and the second protruding patterns 132 may be located at the same level in a thickness direction (e.g., third direction Z) of the strengthened glasses 120 and 130. Being at the same level refers to distal ends of the first and second protruding patterns 122 and 132 being at a same distance from a common reference, such as a common surface of the strengthened glasses 120 and 130. If the bottom surfaces of the glass body 123 and 133 are coplanar with each other, such coplanar surface may be the common surface. The bottom surfaces of the glass body 123 and 133 in FIG. 4 may be considered coplanar for convenience of illustration. Where a single plane in the first and second directions X and Y is defined within the glass body 123 and 133, such single plane may be the common surface.

A maximum height h₃ of the second protruding patterns 132 may be greater than a maximum height h₂ of the first protruding patterns 122. That is, the first reference surface 121 may be located higher than the second reference surface 132 with reference to a common surface or plane. A maximum width w₃ of the second protruding patterns 132 may be greater than a maximum width w₂ of the first protruding patterns 122. A minimum distance d₃ between adjacent second protruding patterns 132 in the first and second directions X and Y may be substantially the same as or greater than a minimum distance d₂ between adjacent first protruding patterns 122 in the first and second directions X and Y.

For example, the maximum height h₂, the maximum width and the minimum distance d₂ may each be within the range of about 100 nm to about 150 nm, and the maximum height h₃, the maximum width w₃ and the minimum distance d₃ may be within the range of about 1 μm to about 10 μm.

In this example, the patterned surface of the strengthened glass 120 of the display portion DA may have a nano-sized ultrafine structure and may provide an antireflection effect for external light in the display portion DA.

Also, in this example, the patterned surface of the strengthened glass 130 of the non-display portion NA may have a micron-sized ultrafine structure and may provide an aesthetic effect by changing the color of light reflected from the non-display portion NA according to the angle from which the electronic device 1000 is viewed.

An upper portion of the strengthened glass 120 of the display portion DA may include a chemically strengthened layer 124, and an upper portion of the strengthened glass 130 of the non-display portion NA may include a chemically strengthened layer 134, as indicated by the shading in FIG. 4. Specifically, at least a portion of the glass body 123 and the protruding patterns 122 may be chemically strengthened and may thus collectively define the chemically strengthened layer 124, and at least a portion of the glass body 133 and the protruding patterns 132 may be chemically strengthened and may collectively define the chemically strengthened layer 134. In an exemplary embodiment, a portion of a thickness of the glass bodies 123 and 133, and an entirety of a height (thickness) of the protruding patterns 122 and 132 may be chemically strengthened to collectively define the chemically strengthened layer 124 and 134 of the strengthened glass 120 and 130, respectively. In an exemplary embodiment, for example, the outer surfaces (e.g., the patterned surfaces) of the strengthened glasses 120 and 130 may have a relatively higher concentration of potassium ions than the inner surfaces (in the exemplary embodiment of FIGS. 3 and 4, the bottom surfaces) of the strengthened glasses 120 and 130. Also, the outer surfaces of the strengthened glasses 120 and 130 may have a relatively lower concentration of sodium ions than the inner surfaces of the strengthened glasses 120 and 130.

One or more exemplary embodiment of a method of manufacturing strengthened glass according to the invention will hereinafter be described.

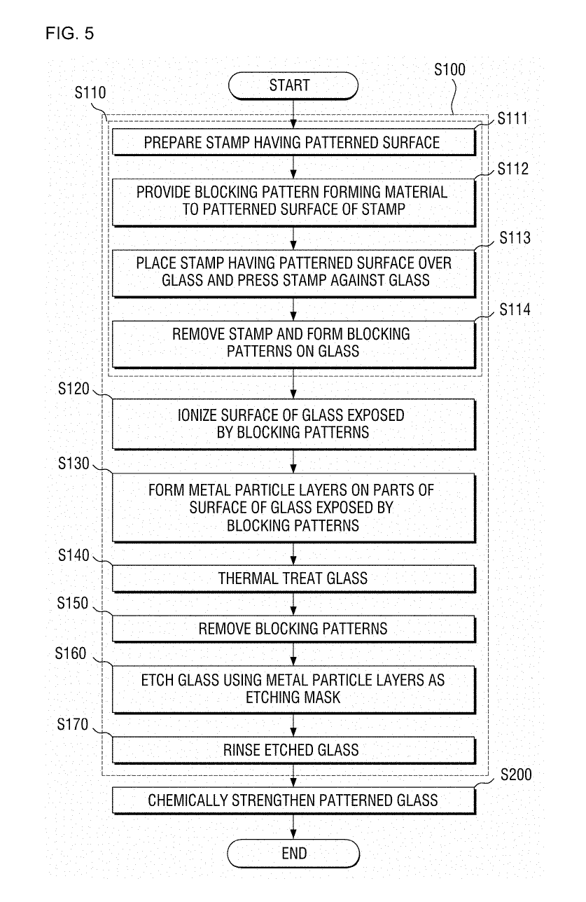

FIG. 5 is a flowchart illustrating an exemplary embodiment of a method of manufacturing strengthened glass according to the invention.

Referring to FIG. 5, the method includes patterning glass (S100) and chemically strengthening the patterned glass (S200). The term “pattern,” as used herein, means a structure having a particular shape, and the term “patterning,” as used herein, means forming a structure having a particular shape. In other words, the term “pattern,” as is used herein, may refer not only to a structure formed on a substrate, but also to a structure obtained by removing a portion of the substrate.

In an exemplary embodiment, for example, the process of patterning glass (S100) may include preparing glass with blocking patterns formed on a surface thereof (S110), forming metal particle layers on the surface of the prepared glass (S130), removing the blocking patterns (S150), and etching the surface of the glass using the metal particle layers as an etching mask (S160). The process of patterning glass (S100) may further include ionizing the surface of the glass (S120), thermally treating the glass (S140), and rinsing the etched surface of the glass (S170). One or more exemplary embodiment of the method of FIG. 5 will hereinafter be described in further detail.

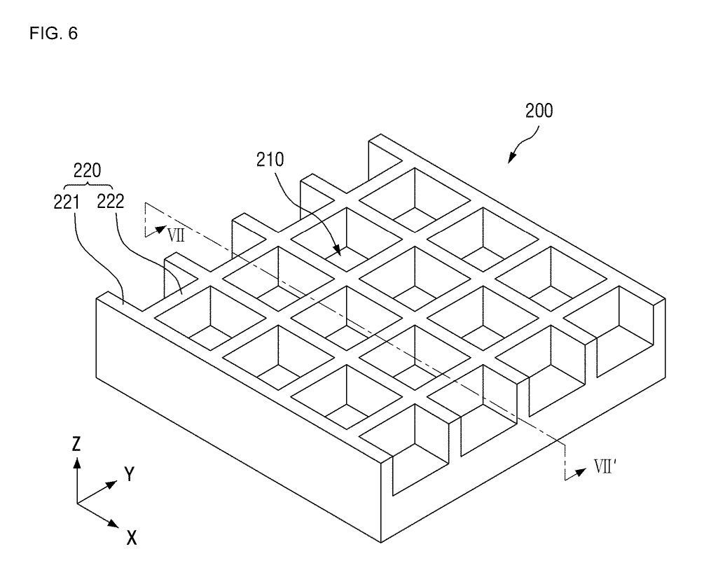

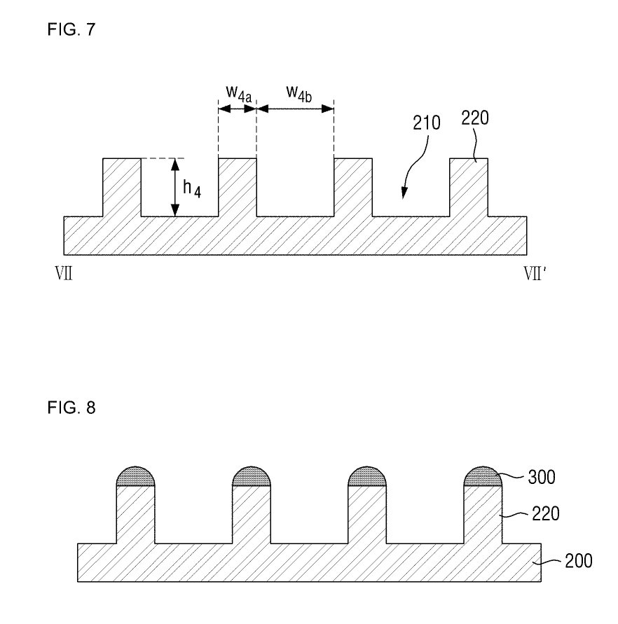

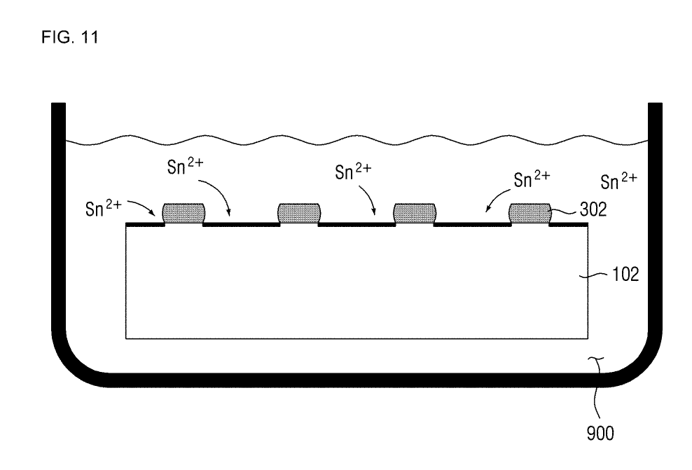

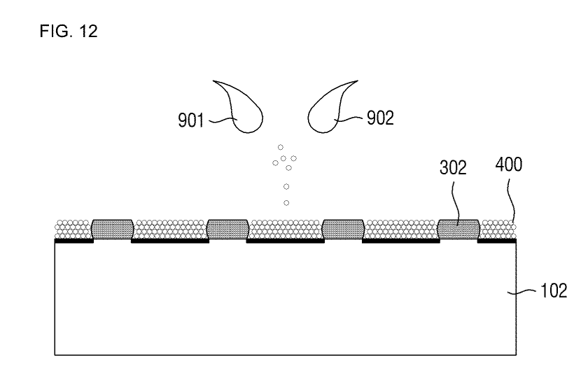

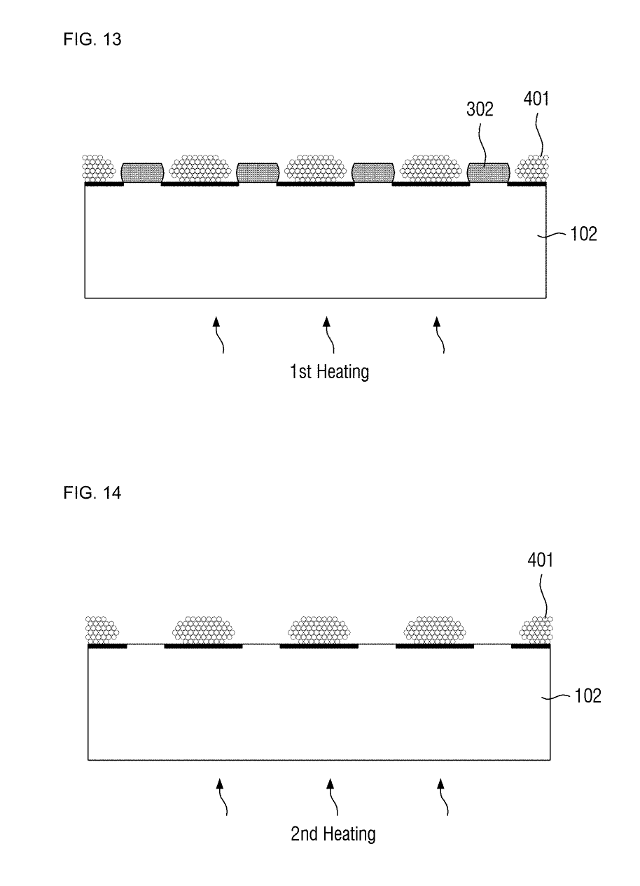

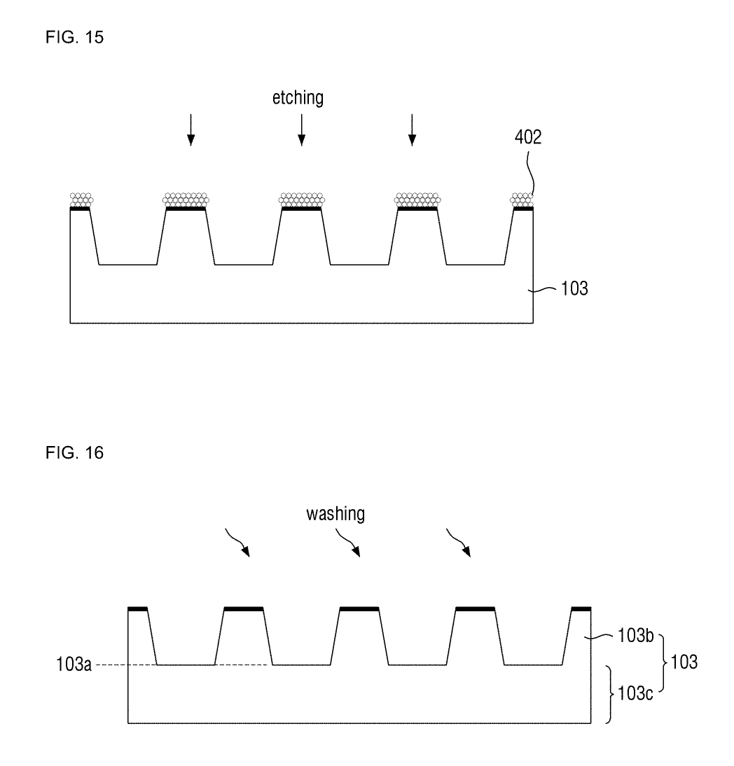

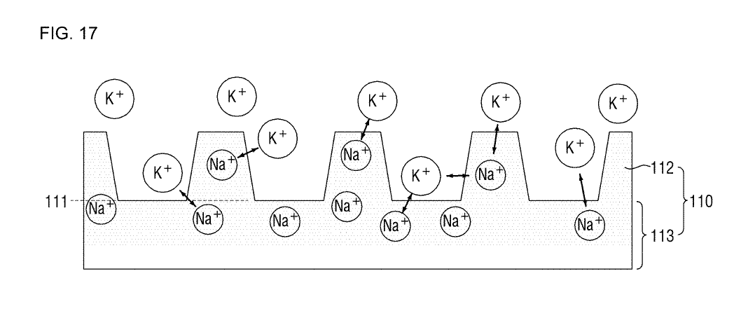

FIGS. 6 through 18 are various schematic views, cross-sectional views and photographs illustrating the method of FIG. 5. Specifically, FIG. 6 is a perspective view of an exemplary embodiment of stamp having a patterned surface, and FIG. 7 is a cross-sectional view taken along line VII-VII′ of FIG. 6. FIGS. 8 through 10 are cross-sectional views illustrating S110 of FIG. 5, e.g., forming glass having blocking patterns formed on a surface thereof. FIG. 11 is a cross-sectional view illustrating S120 of FIG. 5, e.g., ionizing exposed parts of the surface of the glass. FIG. 12 is a cross-sectional view illustrating S130 of FIG. 5, e.g., forming metal particle layers on the exposed parts of the surface of the glass. FIG. 13 is a cross-sectional view illustrating S140 of FIG. 5, e.g., performing a thermal treatment on the glass. FIG. 14 is a cross-sectional view illustrating S150 of FIG. 5, e.g., removing the blocking patterns. FIG. 15 is a cross-sectional view illustrating S160 of FIG. 5, e.g., etching the surface of the glass. FIG. 16 is a cross-sectional view illustrating S170 of FIG. 5, e.g., rinsing the etched surface of the glass. FIG. 17 is a cross-sectional view illustrating S200 of FIG. 5, e.g., chemically strengthening the patterned glass.

Referring to FIGS. 6 and 7, a stamp 200 having a patterned surface is prepared (S111). With reference to a first surface (for example, the collective top surface) of the stamp 200, the stamp 200 is patterned to include a concave portion 210 provided in plurality and a convex portion 220 provided in plurality. In an exemplary embodiment, for example, each of the concave portions 210 may account for a lowest point of the first surface of the stamp 200, and the convex portions 220 may protrude from the concave portions 210 to account for a highest point of the first surface of the stamp 200.

The convex portions 220 may include a first convex portion 221 provided in plurality, which each lengthwise extends in the first direction X, and a second convex portion 222 provided in plurality, which each lengthwise extends in the second direction Y. That is, the convex portions 220 may be substantially lattice-shaped in a plan view. The distal ends or tops of the convex portions 220 may be flat and may have a predetermined planar area.

While FIG. 7 illustrates a view along the first direction X, the structures of FIG. 7 may be applied along the second direction Y. The concave portions 210 may be island-shaped in a plan view and may be spaced apart from one another in the first and second directions X and Y. In an exemplary embodiment, for example, a height h₄ of the convex portions 220 (or depth of the concave portion 210) may be about 100 nm to about 150 nm, and a width w₄ₐ of the convex portions 220 may be about 100 nm to about 150 nm. The width of the first convex portions 221 may be substantially the same as the width of the second convex portions 222. In an exemplary embodiment, for example, a width w_{4b} of the concave portions 210 may be about 100 nm to about 150 nm. In another embodiment, the height h₄, the width w₄ₐ and the width w_{4b} may all be about 1 μm to about 10 μm.

In some exemplary embodiments, the width of the concave portions 210, e.g., the width w_{4b}, may be greater than the width of the first convex portions 221 and the second convex portions 222, e.g., the width w₄ₐ. By making the width w_{4b} greater than the width w₄ₐ, a plurality of protruding patterns having a uniform width and size and having an inclined sidewall can be formed at a surface of a glass form, such as a plate or sheet. FIG. 6 illustrates an example in which the sidewalls of the convex portions 220 are perpendicular to the bases of the concave portions 210, but the sidewalls of the convex portions 220 may be inclined with respect to the bases of the concave portions 210.

A plurality of concavo-convex patterns including the concave portions 210 and the convex portions 220 may be formed at the first surface of the stamp 200 by, for example, laser interference lithography, electron beam lithography or nano-imprint lithography. For example, the stamp 200 may be a relatively soft gel-state stamp including polydimethylsiloxane (“PDMS”).

Thereafter, referring to FIG. 8, a blocking pattern forming material 300 is provided to at least portion of the patterned surface of the stamp 200 (S112), The blocking pattern forming material 300 may be disposed at distal ends of the convex portions 220 of the stamp 200. A method to provide the blocking pattern forming material 300 to the stamp 200 is not particularly limited, but the blocking pattern forming material 300 may be provided using, for example, pad printing, knife coating, kiss coating or gravure coating.

In an exemplary embodiment, for example, the blocking pattern forming material 300 may be a self-assembling material. In an exemplary embodiment, for example, the blocking pattern forming material 300 may be a silane-based or phosphate-based material having a hydrophobic surface. In another example, the blocking pattern forming material 300 may be a trichlorosilane-based, trimethoxysilane-based or dimethyldichlorosilane-based material. In still another example, the blocking pattern forming material 300 may be octadecyltrichlorosilane, octadecyltrimethoxysilane, pentadecyltrichlorosilane, polyethyleneimine trimethoxysilane, perfluorooctyl trichlorosilane or perfluorodecyl trichlorosilane.

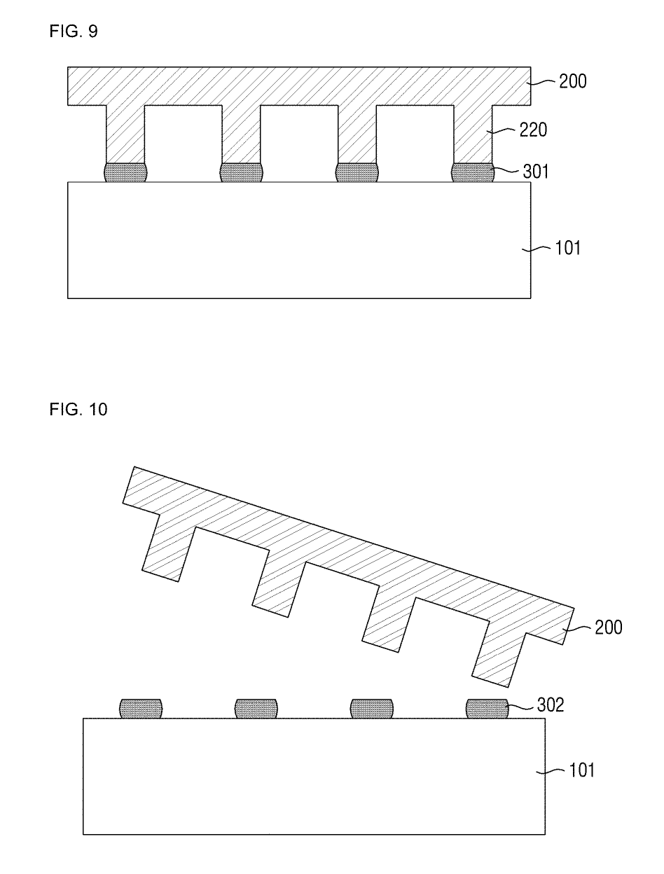

Thereafter, referring to FIG. 9, the stamp 200 having the blocking pattern forming material 300 on the patterned surface thereof is arranged to face a first surface of glass form 101 and is then pressed against the glass form 101 (S113). The glass form 101 may be a planar or plate shaped member, but the invention is not limited thereto. The pressing of the stamp 200 against the glass form 101, e.g., S113, may include deforming the original blocking pattern forming material 300 to be transferred as a blocking pattern forming material 301 on the first surface (e.g., the top surface) of the glass form 101. In a case in which the blocking pattern forming material 301 shown in FIG. 9 is formed from a self-assembling material as the original blocking pattern forming material 300, the blocking pattern forming material 301 may be transferred from the stamp 200 to the surface of the glass form 101 due to its chemical selectivity with respect to the surface of the stamp 200 or the glass form 101. In an exemplary embodiment, for example, the self-assembling material may form a self-assembled monolayer having a relatively strong chemical bonding to a hydrophilic group such as a hydroxyl group (—OH) exposed on the surface of the glass form 101.

Thereafter, referring to FIG. 10, the stamp 200 is removed from the glass form 101 to maintain the blocking pattern forming material 301 on the glass form 101 and form blocking patterns 302 on the surface of the glass form 101 (S114). The blocking patterns 302 may include the same material as the blocking pattern material 300 or 301. The outer surfaces of the blocking patterns 302 may be hydrophobic relative to parts of the surface of the glass 101 at which the blocking patterns 302 are not disposed. Portions of the surface of the glass form 101 at which the blocking patterns 302 are not disposed are exposed by and between the blocking patterns 302. That is, the blocking patterns 302 may partially modify the otherwise entirely planar surface of the glass 101. Although not specifically illustrated, the blocking patterns 302, which are formed by blocking pattern forming material being transferred from the convex portions 220 on the patterned surface of the stamp 200, include portions extending in the first direction X and portions extending in the second direction Y and may thus be substantially lattice-shaped in a plan view owing to the portions 221 and 222 of the convex portions 220 being arranged in a lattice shape.

Thereafter, referring to FIG. 11, portions of the surface of a glass form 102 which are exposed by the blocking patterns 302 because of the blocking patterns 302 not being disposed thereon are ionized (S120). For example, the portions of the surface of the glass form 102 exposed by the blocking patterns 302 may be modified by treating the surface of the glass form 102 with tin ions (Sn²⁺) or fluorine ions (F⁻). As a result, the adsorbability of a metal-based material on the exposed portions of the surface of the glass form 102 can be improved.

In an exemplary embodiment, for example, the treating the portions of the surface of the glass form 102 exposed by the blocking patterns 302 with tin ions or fluorine ions, e.g., 5120, may include immersing the glass form 102 with the blocking patterns 302 formed on the surface thereof in a tin salt solution 900 (or a fluoride salt solution). The exposed portions of the surface of the glass form 102 may be ionized by placing the exposed portions of the surface of the glass form 102 in direct contact with tin ions (Sn²⁺) in the tin salt solution 900 (or fluorine ions (F⁻) in the fluoride salt solution). The tin ions (Sn²⁺) in the tin salt solution 900 may selectively penetrate into the exposed portions of the surface of the glass form 102. Examples of the tin salt solution 900 or the fluoride salt solution include a tin chloride (SnCl₂) solution, a tin fluoride (SnF²) solution, and the like, but the present disclosure is not limited thereto.

Thereafter, referring to FIG. 12, a metal particle 400 is formed in plurality as a collection of metal particle layers 400 on the ionized portions of the surface of the glass form 102 (S130). As described above, the formation of the metal particle layers 400 may be facilitated by treating the exposed portions of the surface of the glass 102 with tin ions or fluorine ions so as to improve the adsorbability of a metal-based material on the glass form 102. Also, metal fine particles can be selectively adsorbed, and self-assembled, on the portions of the surface of the glass form 102 exposed by the blocking patterns 302, without the aid of a physical imprinting method. Also, relatively high-resolution etching can be performed by using the metal particle layers 400 as a mask. Also, ultrafine patterns having a size of several hundreds of nanometers or less can be formed by a relatively simple process.

The forming the metal particle layers 400 on the portions of the surface of the glass form 102 exposed by the blocking patterns 302, e.g., S130, may include combining a first solution 901 and a second solution 902 which reacts with the first solution 901, to produce metal particles, and providing the combination the first and second solutions 901 and 902 to the surface of the glass form 102. In an exemplary is embodiment, for example, S130 may include forming the metal particle layers 400 by precipitating metal particles on the ionized portions of the surface of the glass form 102. In a non-limiting example, the first solution 901 may be a solution containing Ag(NH₃)₂, the second solution 902 may be a solution containing KNaC₄H₄O₆, and the metal particles may be Ag particles.

Although not specifically illustrated, the metal particle layers 400, which are formed on the portions of the surface of the glass 102 exposed by the blocking patterns 302 that are substantially lattice-shaped, may be island-shaped in a plan view and may be spaced apart from one another in the first and second directions X and

Thereafter, referring to FIG. 13, the glass form 102 including the metal particle layers 400 between the blocking patterns 302 is thermally treated (S140). The thermally treating (indicated by ‘1^{st} Heating’ in FIG. 13) the glass form 102, e.g., S140, may include coagulating metal particles to form in metal particle layers 401 through the thermal treatment. By coagulating the metal particles in the formed metal particle layers 401, the collection of metal particle layers 401 can be relatively firmly formed and can thus be used as an etching mask. The metal particles in the collection of metal particle layers 401 are coagulated such that ends of each of the metal particle layers 401 which were initially in contact with the glass form 102 (refer to FIG. 12) can be lifted off of the glass form 102 to be spaced apart therefrom (refer to FIG. 13). Then, by using the collection of metal particle layers 401 as an etching mask, a plurality of protruding patterns can be regularly formed on the surface of the glass form 102 to have an inclined sidewall. S140 may be performed at a temperature of about 100 degrees Celsius (° C.) to about 150° C. or more particularly, about 120° C. to about 130° C.

Thereafter, referring to FIGS. 13 and 14, the blocking patterns 302 are removed from the surface of the glass form 102 (S150). In an exemplary embodiment, for example, the removing the blocking patterns 302, e.g., S150, may include exhausting the blocking patterns 302 by performing a secondary thermal treatment (indicated by ‘2^{nd} Heating’ in FIG. 13) on the glass form 102 having the blocking patterns 302 thereon so as to leave only the collection of metal particle layers 401 on the surface of the glass form 102. S150 may be performed at a temperature of about 350° C. to about 450° C. or more particularly, about 400° C. to about 420° C. If S150 is performed at a temperature of about 350° C. or higher, the blocking patterns 302 may be completely exhausted, and if S150 is performed at a temperature of about 450° C. or lower, damage may not be caused to the metal particle layers 401. In an exemplary embodiment, for example, S140 and S150 may be integrally (e.g., simultaneously) performed by increasing the temperature in a chamber where S140 and S150 are performed. In another example, S150 may be performed by partially rubbing the surface of the glass form 102 having the blocking patterns 302 thereon, using a cleaning solution that can dissolve the blocking patterns 302, or by performing an aching process. After S140 and S150, the collection of metal particle layers 401 remain on the glass form 102.

Thereafter, referring to FIGS. 14 and 15, the surface of the glass form 102 having the collection of metal particle layers 401 thereon is etched (indicated by ‘etching’ in FIG. 15) using the metal particle layers 401 as an etching mask (S160), thereby obtaining etched an glass form 103. Specifically, patterns can be formed in the glass form 102 by etching the portions of the surface of the glass form 102 exposed by the collection of metal particle layers 401. That is, an etching reaction caused by an etchant or an etching gas does not occur at portions of the surface of the glass form 102 where the metal particle layers 401 are disposed. Thus, the portions of the surface of the glass form 102 where the metal particle layers 401 are disposed may remain unetched. A portion of the metal particle layers 401 may be removed during S160, such that a reduced collection of metal particle layers 402 may remain on the unetched portions of the glass form 102.

Processing conditions for the etching the surface of the glass form 102, e.g., S160, such as the type of etchant, etching gas and/or plasma used, etching temperature and etching duration, may be appropriately determined in consideration of the material of the glass form 102, the type of metal particles in the metal particle layers 401, and the etch selectivity of the glass form 102 relative to the metal particle layers 401. In an exemplary embodiment, for example, S160 may be performed by reactive ion etching (“RIE”) or inductively coupled plasma (“ICP”) etching.

Thereafter, referring to FIG. 16, the etched glass 103 is rinsed or washed (S170). In an exemplary embodiment, for example, the rinsing the etched glass 103, e.g., S170, may include immersing the etched glass 103 in a nitric acid solution, but the invention is not limited thereto. As a result of S170, the metal particle layers 402 may be completely removed from the surface of the etched glass form 103.

The etched glass form 103 includes a protruding pattern 103b provided in plurality each of which protrudes from an imaginary reference surface 103a, and a glass body 103c, which is disposed below the protruding patterns 103b and commonly connects the protruding patterns 103b to one another. In an exemplary embodiment, for example, the etched glass form 103 may have the same patterned surface as the strengthened glass 110 of FIGS. 1 and 2. That is, the protruding patterns 103b may be regularly arranged, and spaced apart from one another, in the first and second directions X and Y. The sidewalls of the protruding patterns 103b may be inclined.

The size of the finally formed protruding patterns 103b may be substantially proportional to the size of the concave portions 210 and the convex portions 220 of the stamp 200 used in forming the etched glass form 103. In an exemplary embodiment, for example, the maximum height and the maximum width of the protruding patterns 103b and the minimum distance between the protruding patterns 103b in the first and second directions X and Y may all be about 100 nm to about 150 nm. In another example, the maximum height and the maximum width of the protruding patterns 103b and the minimum distance between the protruding patterns 103b in the first and second directions X and Y may all be about 1 μm to 10 μm.

Thereafter, referring to FIGS. 16 and 17, the etched glass form 103 defined by the glass body 103c and the protruding patterns 103b is chemically strengthened (S200), thereby obtaining chemically strengthened glass 110. The chemically strengthening the etched glass form 103 having the glass body 103c and the protruding patterns 103b, e.g., S200, may include substituting first alkali metal ions in the etched glass form 103 with second alkali metal ions having a larger ionic radius than the first alkali metal ions. In an exemplary embodiment, for example, the first alkali metal ions may be lithium ions, and the second alkali metal ions may be sodium or potassium ions. In another example, the first alkali metal ions may be sodium ions, and the second alkali metal ions may be potassium ions. In an exemplary embodiment, for example, the etched glass form 103 may be chemically strengthened through ion exchange by being immersed in a solution containing the second alkali metal ions. The chemically strengthened glass 110, which is obtained by chemically strengthening the etched glass form 103, may be the same as the strengthened glass 110 of FIGS. 1 and 2. The chemically strengthened glass 110 may be as already described above with reference is to FIGS. 1 and 2, and thus, a detailed description thereof will be omitted.

According to the method of FIG. 5, since a top surface of a glass form includes not only planar surfaces (e.g., at the imaginary reference surface) but also includes surfaces at the sidewall and top of the protruding patterns, a total surface area of the top surface of a glass form can be increased by patterning the surface of the glass (S100) and then chemically strengthening the glass (S200). Accordingly, the efficiency of chemically strengthening glass can be maximized.

A preparation example of the present disclosure will hereinafter be described.

### PREPARATION EXAMPLE

Patterns including lattice-shaped convex portions whose height and width were both about 1 μm were formed at a surface of polydimethylsiloxane substrate to make a stamp. Then, octadecyltrichlorosilane was applied to the patterned surface of the stamp using a cotton swab. Then, octadecyltrichlorosilane was transferred from the stamp onto a top surface of a soda lime glass form using the stamp, thereby forming blocking patterns on the glass form. The glass form with the blocking patterns formed thereon was immersed in a SnCl₂ solution for 10 minutes and was taken out of the solution. Then, a Ag (NH₃)₂ solution and a KNaC₄H₄O₆ solution were allowed to react with each other at a distance of 30 centimeters (cm) from the top surface of the glass form, and the resulting reaction solution was placed in contact with the glass form. Then, the temperature was raised from room temperature to 400° C. for 30 minutes and was maintained at 400° C. for 5 minutes. Then, the top surface of the glass form was etched, and the etched glass form was immersed in a nitric acid solution and was taken out of the solution. The etched glass form was then chemically strengthened by being immersed in a solution containing potassium ions.

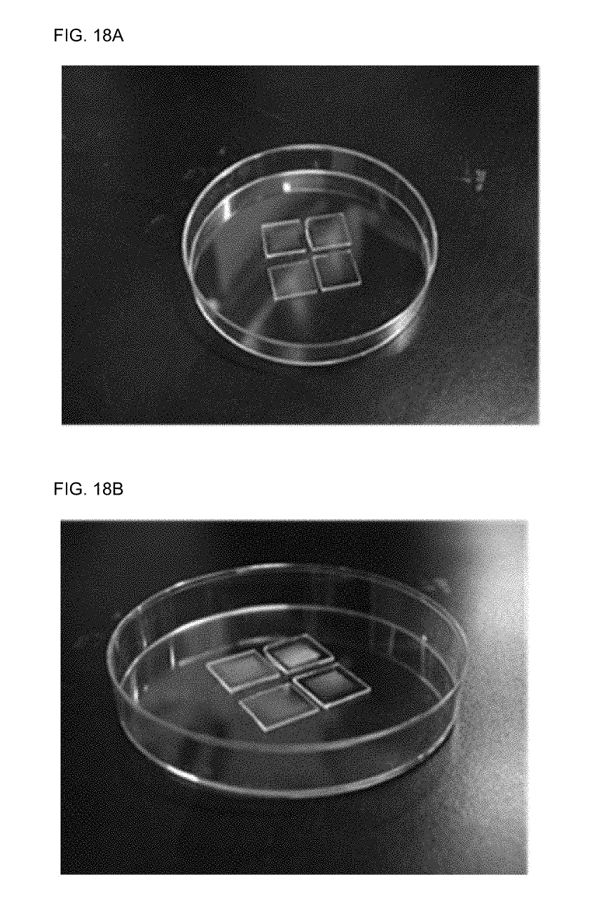

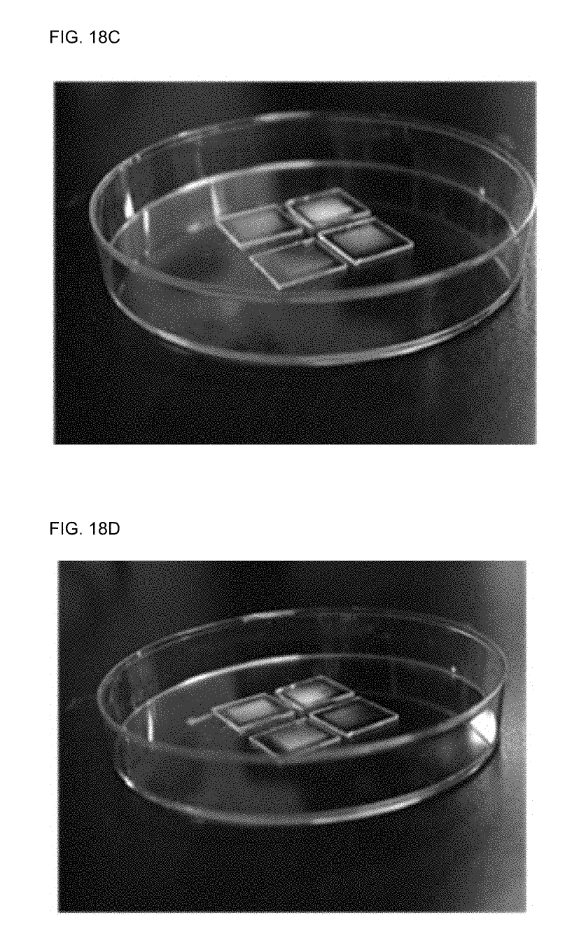

FIGS. 18A through 18D are photographs of strengthened glass manufactured according to a preparation example of the present disclosure. Specifically, FIGS. 18A through 18D are photographs of a same strengthened glass as viewed sequentially from positions at a high point of view (FIG. 18A) to a low point of view (FIG. 18D).

Referring to FIGS. 18A through 18D, it is apparent that the color of light reflected from the strengthened glass changes according to the angle from which the strengthened glass is viewed, thereby providing a “rainbow reflection” effect.

While the invention has been particularly illustrated and described with reference to exemplary embodiments thereof, it will be understood by those of ordinary skill in the art that various changes in form and detail may be made therein without departing from the spirit and scope of the invention as defined by the following claims. The exemplary embodiments should be considered in a descriptive sense only and not for purposes of limitation.

What is claimed is:

1. A method of manufacturing strengthened glass, comprising:
preparing glass comprising blocking patterns on a surface thereof, portions of the surface exposed between the blocking patterns;
forming a metal particle layer on the portions of the surface of the glass exposed between the blocking patterns;
removing the blocking patterns from the surface of the glass, to maintain the metal particle layer on the surface of the glass;
with the metal particle layer maintained on the surface of the glass, etching the surface of the glass using the metal particle layer as an etching mask to form an etched surface of the glass, such etched surface comprising protruding patterns spaced apart from each other by portions of a common reference surface; and
chemically strengthening the etched surface of the glass at the protruding patterns and at the reference surface.

2. The method of claim 1, wherein the preparing the glass comprising the blocking patterns on the surface thereof, comprises:
preparing a stamp which has a patterned surface including concave portions and convex portions,
providing a blocking pattern forming material on the convex portions of the stamp, and
forming the blocking patterns on the surface of the glass by transferring the blocking pattern forming material from the stamp onto the surface of the glass by using the stamp.

3. The method of claim 2, wherein the convex portions of the stamp include:
first convex portions which lengthwise extend in a first direction, and
second convex portions which lengthwise extend in a second direction which intersects the first direction,
the first and second convex portions forming a lattice-shape in a plan view of the stamp.

4. The method of claim 2, wherein the blocking patterns comprise a material comprising trichlorosilane, trimethoxysilane or dimethyldichlorosilane.

5. The method of claim 2, wherein the blocking patterns on the surface of the glass are hydrophobic relative to the surface of the glass.

6. The method of claim 5, further comprising, between the preparing the glass comprising the blocking patterns on the surface thereof and the forming the metal particle layer:
treating the portions of the surface of the glass exposed by the blocking patterns with tin ions or fluorine ions.

7. The method of claim 6, wherein
metal particles in the metal particle layer comprise silver (Ag) particles, and
the forming the metal particle layer comprises precipitating silver (Ag) on the portions of the surface of the glass treated with the tin ions or the fluorine ions.

8. The method of claim 7, further comprising, after the etching the surface of the glass:
immersing the glass having the etched surface in a nitric acid solution.

9. The method of claim 1, wherein the removing the blocking patterns to maintain the metal particle layer on the surface of the glass, comprises thermally treating the glass having the blocking patterns and the metal particle layer thereon at a temperature of 350° C. to about 450° C.

10. The method of claim 1, wherein the chemically strengthening the etched surface of the glass, comprises substituting first alkali metal ions in the protruding patterns and at the reference surface of the glass with second alkali metal ions having a larger ionic radius than the first alkali metal ions.

11. Strengthened glass comprising:
a chemically strengthened patterned surface, such patterned surface defined by a plurality of chemically strengthened protruding patterns protruding from a common reference surface,
wherein
the chemically strengthened protruding patterns are regularly arranged to be spaced apart from one another by portions of the common reference surface, in a first direction and a second direction which intersects the first direction in a plan view.

12. The strengthened glass of claim 11, further comprising:
a glass body which defines the common reference surface from which the chemically strengthened protruding patterns are protruded, such glass body commonly connecting the chemically strengthened protruding patterns to one another in the first and second directions,
wherein
the glass body and the chemically strengthened protruding patterns form one integral body without physical boundaries therebetween, and
the glass body comprises a chemically strengthened portion extending from the common reference surface.

13. The strengthened glass of claim 12, wherein sidewalls of the chemically strengthened protruding patterns are inclined with respect to the common reference surface of the glass body from which the chemically strengthened portion thereof extends.

14. The strengthened glass of claim 13, wherein the chemically strengthened portion protruding patterns are circular in the plan view.

15. The strengthened glass of claim 14, wherein the patterned surface has a compressive stress of about 600 megapascals to about 2000 megapascals.

16. An electronic device comprising:
a display portion at which an image is displayed;
a non-display portion at which the image is not displayed; and
an outer glass disposed in the display portion and in the non-display portion,
wherein
an outer glass surface of the display portion is defined by first protruding patterns which protrude from a first reference surface,
an outer glass surface of the non-display portion is defined by second protruding patterns which protrude from a second reference surface, and
a maximum height of the second protruding patterns from the first reference surface is greater than a maximum height of the first protruding patterns from the second reference surface.

17. The electronic device of claim 16, wherein
the first protruding patterns and the second protruding patterns are spaced apart from each other, and
a minimum distance between the second protruding patterns is greater than a minimum distance between the first protruding patterns.

18. The electronic device of claim 17, wherein
the first protruding patterns spaced apart from each other are regularly arranged in a first direction and a second direction which intersects the first direction,
the second protruding patterns spaced apart from each other are regularly arranged in the first and second directions, and
tops of the first protruding patterns and tops of the second protruding patterns are located at the same level from a common reference within the outer glass.

19. The electronic device of claim 18, wherein
the maximum height of the first protruding patterns is about 100 nanometers to about 150 nanometers, and
the maximum height of the second protruding patterns is about 1 micrometer to about 10 micrometers.

20. The electronic device of claim 16, wherein
the outer glass surface of the display portion comprises chemically strengthened first protruding patterns which protrude from the first reference surface, and
the outer glass surface of the non-display portion comprises chemically strengthened second protruding patterns which protrude from the second reference surface.
